(19) United States
(12) Patent Application Publication
(10) Pub. No.: US 2005/0117022 A1
(43) Pub. Date: Jun. 2, 2005

(54) Image capture and retrieval apparatus

(76) Inventor: Stephen John Marchant, Cragg Vale (GB)

Correspondence Address: SMITH-HILL AND BEDELL, 12670 N W BARNES ROAD, SUITE 104, PORTLAND, OR, 97229, US

(21) Appl. No.: 10/507,528

(22) PCT Filed: Feb. 20, 2003
(86) PCT No.: PCT/GB03/00725

(30) Foreign Application Priority Data
Mar. 9, 2002 (GB) 0205601.8

(51) Int. Cl. H04N 5/225

(52) U.S. Cl. 348/207.11

(57) ABSTRACT

An image capture and retrieval apparatus includes a camera unit including a high resolution image sensor for capturing data relating to a visual image, a radio transmitter and radio receiver for triggering the image sensor of the camera unit to capture image data at a predetermined time and/or location. The apparatus further includes a base station for retrieving and processing image data and a camera unit including data storage means for transmitting the image data, the moveable unit being adapted for conveying to the base station image data captured by the image center at a location remote from the base station.

The invention relates to the capture and retrieval of images, particularly high resolution digital images. The invention may have particular application in theme parks, for taking pictures of roller coasters or other moving ride vehicles.

According to the invention there is provided an image capture and retrieval apparatus including:
an image sensor for capturing data relating to a visual image;
means for triggering the image sensor to capture the image data at a predetermined time and/or location;
a base unit for retrieving and processing the image data; and
a moveable unit including data storage means for storing the image data and data transmission means for transmitting the image data, the moveable unit being adapted for conveying to the base station image data captured by the image sensor at a location remote from the base station.

Preferably the moveable unit is able to convey data from a remote location at least 10 m away from the base station.

Preferably the image sensor forms part of the moveable unit.

Preferably the moveable unit further includes a light source for illuminating the image. The light source may include a flash unit or one or more light emitting diodes.

Preferably the apparatus includes a means for triggering the light source to provide illumination when the image sensor is triggered to capture the image data.

Preferably the moveable unit further includes a power source. The moveable unit may further include a power controller for switching power on and off as required by the data storage means, the data transmission means, the image sensor and the light source. The moveable unit may include a motion detector for use in placing the battery in a low power state when the moveable unit is stationary and the data transmission means are not operating.

The means for triggering the image sensor to capture the image data may include a radio receiver located on the moveable unit.

The data transmission means may include a radio transmitter. The radio transmitter may include means for transmitting the image data in discrete blocks.

Preferably the moveable unit includes means for removably attaching it to a vehicle unit. The vehicle unit may include wheels or may be adapted to travel on a track. The vehicle unit may comprise, or form part of, a car for a roller coaster or similar amusement ride.

Preferably the transmission means on the moveable unit includes means for transmitting information relating to the status of the moveable unit. Such information may include battery charge state, number of images captured, and information relating to the status of the light source.

Preferably the moveable unit includes a housing which is no more than 0.3 metres in height, 0.3 metres in width and 0.1 metres in depth. Most preferably, the housing is no more than 0.2 metres in height, 0.2 metres in width and 0.05 metres in depth. Preferably substantially all the components of the moveable unit are contained within the housing. Preferably the moveable unit weighs less than 1 Kg.

The housing may include a front surface including two clear optical windows for the image sensor and the light source respectively. Preferably the windows are made of plastics material.

Preferably the housing is waterproof. The housing may be made of plastics material.

Preferably the housing includes means for attaching it to the vehicle unit, for carrying the moveable unit.

Preferably the housing includes means for attaching a battery charger thereto.

The apparatus may include a plurality of moveable units each including any of the aforementioned features. Preferably each moveable unit is uniquely identified such that the base station may identify image data transmitted therefrom.

The apparatus may include a track extending between the base unit and the remote location, defining a predetermined route for the moveable unit. The means for triggering the image sensor to capture the image data may include a stationary trigger unit located at a predetermined position on the predetermined route. The trigger unit may include a radio transmitter for providing a signal receivable by the radio receiver on the moveable unit.

Preferably the base station includes interrogation means for causing the transmission of image data from a moveable unit. The interrogation means may include means for providing a radio signal receivable by the radio receiver on the moveable unit.

Preferably the base station includes processor means for converting the image data to RGB data for image display. Preferably the base station includes means for checking the image data for errors and triggering the transmission means on the moveable unit to re-transmit image data if required.

The base station may include means for receiving image data transmitted in discrete blocks. Preferably the base station includes means for reconstructing an image from blocks of data received in any arbitrary order. Preferably each data block includes a sequence number.

According to the invention, there is further provided a method for image capture and retrieval, the method including the steps of:
triggering an image sensor to capture data relating to a visual image, at a predetermined location;
storing the image data and conveying the image data on a moveable unit to a base unit remote from the predetermined location;
transmitting the image data to the base unit; and
processing the image data at the base unit.

Preferably the image sensor is conveyed with the moveable unit. The moveable unit may be conveyed on a vehicle unit, which includes wheels or runs on a track.

The method may further include the step of triggering a light source to illuminate the image when the image sensor is triggered to capture the image data.

The image data may be transmitted to the base unit via radio transmission. The image data may be transmitted in discrete blocks.

An embodiment of the invention will be described for the purpose of illustration only with reference to the accompanying drawings in which:

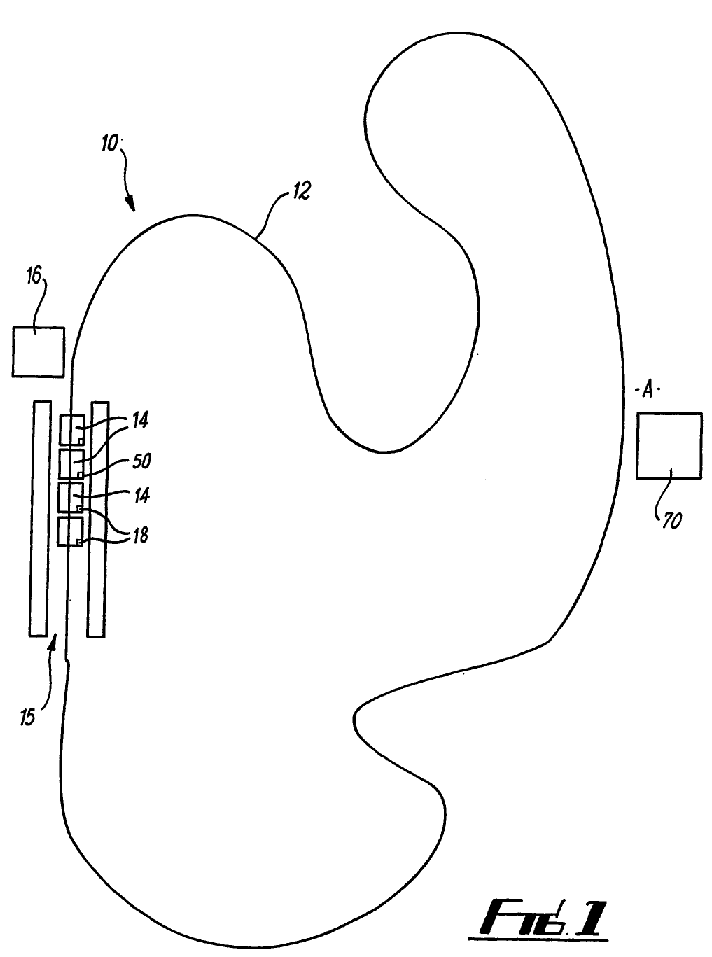

FIG. 1 is a diagrammatic sketch illustrating one application of the invention;

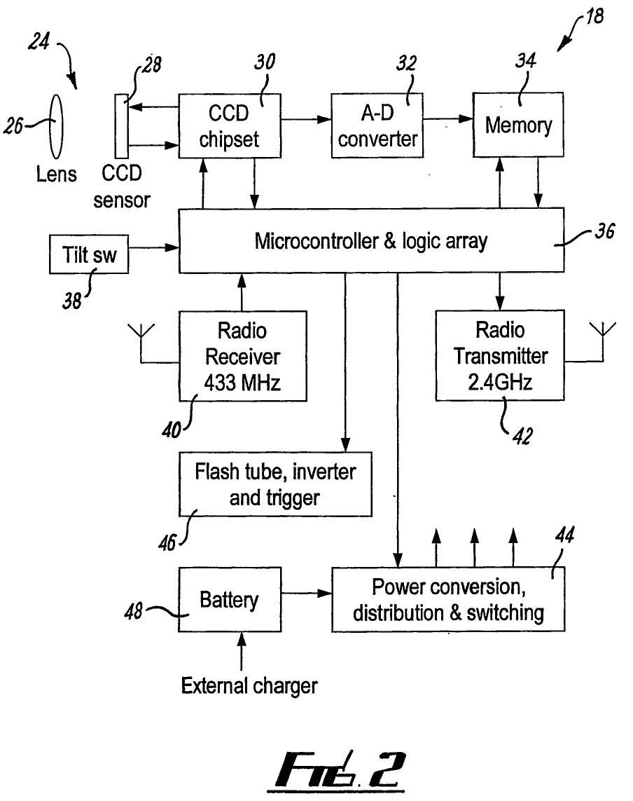

FIG. 2 is a block diagram of a camera unit according to the invention; and

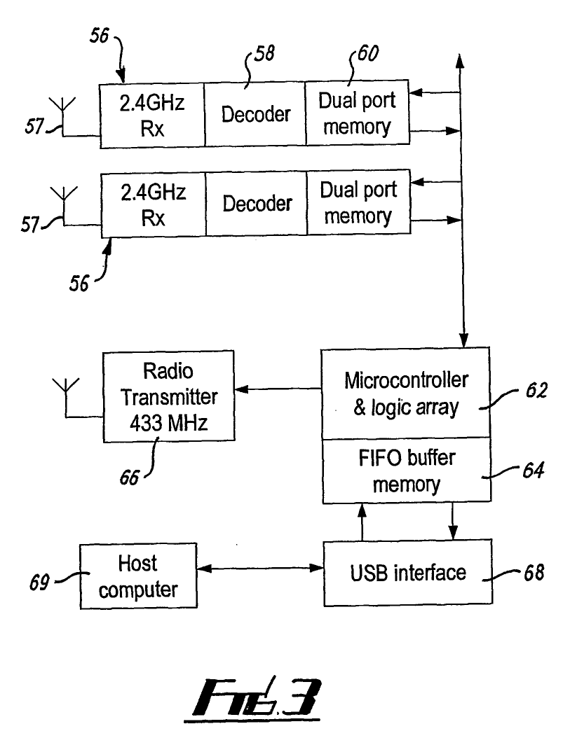

FIG. 3 is a block diagram of a base station according to the invention.

Referring to FIG. 1, a particular application of the invention is in taking photographs of riders on a roller coaster. FIG. 1 illustrates a roller coaster 10 including a track 12 on which cars 14 are mounted for movement, as indicated by the arrow. The cars accommodate people riding on the roller coaster, the people mounting and dismounting the cars at a station 15.

Apparatus according to the invention includes a stationary base station 16 and moveable units in the form of a number of camera units 18. Each camera unit 18 is mounted on one of the cars 14 of the roller coaster. The camera units 18 are adapted to travel on the roller coaster cars 14 between the base station 16 and one or more remote locations (e.g., location A in FIG. 1). The remote locations are the positions at which it is intended to take photographs of people travelling on the roller coaster in the cars 14.

Referring to FIG. 2, each camera unit 18 includes a high resolution image sensor 24 including a lens 26, a CCD sensor 28 and a CCD chipset 30. The CCD sensor 28 includes a plurality of pixels arranged in the Bayer filter pattern.

The camera unit 18 further includes an analogue to digital converter 32 and a memory 34. The CCD chipset 30 and the memory 34 each communicate with a microcontroller and logic array 36. The microcontroller is also able to receive an input from a tilt switch 38 and from a radio receiver 40.

The camera unit 18 further includes a radio transmitter 42, a power source in the form of a conversion, distribution and switching housing 44 and a light source in the form of a flash tube, inverter and trigger 46. The power box 44 is in communication with a battery 48, which has a link for connection to an external charger. The microcontroller 36 is able to send signals to the radio transmitter 42, the power box 44 and the flash tube 46.

The camera unit 18 (including the above components), is contained within a housing 50 (illustrated diagrammatically in FIG. 1), the housing having dimensions of no greater than 0.2 metres high 0.2 metres wide and 0.05 metres deep. The whole unit weighs less than 1 Kg.

The housing 50 is made of a high impact plastics material, waterproof to a level of IP67. This means the unit is totally protected against dust and can be submersed in water to a depth of between 15 cm and 1 m for 30 minutes without any ingress of water.

In a front surface of the housing 50 there are provided two clear optical plastics windows (not visible in the drawings), one for the lens 26 and one for the light source (provided by the flash tube 46).

On a rear surface of the housing 50, there is a quick release, secure mounting assembly to allow it to be attached to or detached from the camera vehicle 20. The housing 50 further includes means whereby a battery charger can be attached to it, for charging the battery 48.

Referring to FIG. 3, the base station 16 includes a plurality of 2.4 GHz receiver modules 56 (two of which are illustrated). Each receiver module 56 is adapted to receive radio transmissions and includes an antenna 57. The antennae are distributed around the base station to maximise the chances of receiving error free data. The receiver modules are each provided with decoder 58 and a dual port memory 60.

The base station further includes processor means in the form of a microcontroller and logic array 62, having a FIFO (First In, First Out) buffer memory 64. A radio transmitter 66 is connected to the microcontroller 62 so that it can receive signals therefrom.

The base station further includes a USB (Universal Serial Bus) interface 68 for connecting the base station to a host computer 69.

The apparatus further includes a fixed radio transmitter 70, positioned near the track 12 at location A. Such a transmitter would be positioned at each location at which it was intended to take a photograph.

In operation, the camera units 18 travel on the cars 14 along the track 12 until they pass the radio transmitter 70 at location A. As a camera unit 18 passes, the radio transmitter 70 is triggered to provide a signal, which is received by the radio receiver 40 of the camera unit 18. The microcontroller 36 then applies a preset time delay before capturing a single image from the image sensor 24, simultaneously triggering the flash tube 46 to provide a flash through one of the windows in the housing 50. The CCD sensor then captures an image which is stored in the memory 34 and this process is repeated as required by any further trigger signals provided by the radio transmitter 70 or other radio transmitters provided at different locations along the track 12.

The power box 44 controls the battery 48 under the overall control of the microcontroller 36. In this way the battery power is switched on and off as required by the various components in the camera unit 18.

Each camera unit 18 continues to move with its car 14 along the track 12 until it reaches a position where it can effectively transmit data to the base station 16. Generally the camera unit would be within 5 metres of the base station at this point, and preferably within about 2 metres the base station 16. The base station 16 provides a radio signal triggered by the proximity of the camera unit 18, the signal being received by the radio receiver 40. This triggers the camera unit 18 to download its image data to the base station 16, using the radio transmitter 42.

Raw, bayer masked, image data (i.e. before any demosaicing algorithms are applied) is transmitted in order to minimise transmission time, local storage and local processing requirements. The host computer 69 converts the raw bayer image data to RGB signals for subsequent display, etc.

The image data is divided into small blocks (640 samples for example) by the camera unit 18 for transmission. Image data blocks include block sequence information, cyclic redundancy check (CRC) data, error detection codes and camera unit identification information.

The base station 16 does not acknowledge each transmitted block of data during the image download. Instead, the whole image is transmitted in one go, and re-tries are subsequently issued, as required, after the initial transmission is complete. This speeds up the overall image download process even when reception performance is poor and re-tries are needed.

Each of the multiple receiver modules 56 checks the CRC code in each image block it receives and rejects any that contain detected errors. An additional (N+1 if there are N receiver modules 56) virtual receiver module could be created from a majority vote (at the raw received data level) of the N real receiver modules 56.

The dual port memory 60 in each receiver module only needs to be matched to the block size rather than the whole image size. However the base station's FIFO buffer memory 64 can hold a complete image, to allow for any degree of computer USB data acceptance latency.

In addition to image data, each camera unit 18 also downloads current status information. This may include battery charge state, number of pictures taken, image exposure time, flash recharge time, etc.

The base station microcontroller 62 takes all the successfully received image blocks from all the receiver modules 56 at its disposal in real time. One copy of each good block is immediately loaded to the USB buffer memory 64 for forwarding to the host computer 69. The base station 16 keeps a log of missing blocks and, once the initial image transmission has completed, requests re-transmission of only the blocks it needs to complete the image. These re-transmitted blocks are one again rejected if errors persist or passed onto the host computer 69, if they are error free. This process of requesting re-transmission of missing blocks continues until the base station is satisfied that the host computer 69, has been sent all the blocks it needs in order to reconstruct the image.

The host computer 69 is equipped with software to reconstruct an image from blocks of data received in any arbitrary order. It is able to do this because each block is sent to the computer, along with its original sequence number.

Once the base station 16 has successfully downloaded an image, it will move on and interrogate the next camera unit 18 for its image. This process is repeated until all available images have been downloaded.

The base station 16 may also uplink various settings to the camera unit 18. For example, the CCD exposure time may be remotely adjusted by the host computer 69, in response to its analysis of the returned images for proper exposure. In addition, the time delay of each camera unit's trigger point may be fine tuned from the host computer. The flash intensity could also be adjusted in this way.

There is thus provided a self contained and robust unit for taking an image at a remote location. By deferring the transmission of images gathered, very high quality pictures may be provided.

Various modifications may be made to the above described embodiment without departing from the scope of the invention. Although the invention has been described as used in a theme park, it may be used in various different applications, for example in sports events to take pictures of fast moving cars, boats, etc, and in industrial and scientific processes to take pictures at inaccessible locations. Instead of radio signals, infrared signals or ultrasound could be used to trigger the acquisition of an image. Alternatively, a sensor directly mounted on the camera unit to detect light, heat, sound, pressure, proximity or temperature, or to analyse the image from the sensor itself, could trigger the acquisition of the image. In addition, an infrared or other light based data transmission system could be used, rather than radio transmission, to communicate the stored images to the base station.

The apparatus could include more than one base station, the unit communicating its images to several different stations along its route.

Further, the moveable unit could be provided with increased storage capacity to allow it to make a short “movie” once triggered rather than simply taking still images. Such increased storage capacity could allow the unit to take a succession of “time-lapse photography” images over the course of a longer time interval, with the start, timing and control of the sequence remotely controllable. This would allow the unit to be sent (for example) in a small remote-controlled aircraft to acquire survey, surveillance or general aerial images and bring them back to ground for further inspection and analysis, without having to transmit them directly as they are taken.

Again using an increased storage capacity unit, the unit could accumulate pictures each time a route (track) was respectively travelled. The unit could accumulate many instances of the given picture taken at the same precise point on the route for access at a later time when sufficient images had been gathered; at this time, the entire batch of images would be recovered from the unit by transmission to the base station

The housing could be made from highly impact resistant and strong materials to allow image capture in extremely harsh environments (for example, in mines, where direct radio telemetry would be impossible, where explosives are used, to take pictures of the actual detonation and retrieve the image for later analysis—this would also allow its use scientifically in destructive testing applications).

The inbuilt flash light source may be replaced by a high efficiency white LED or other light source to allow rapid image sequences to be acquired in poor lighting conditions where the recycle time of the flash circuitry would otherwise preclude this.

The unit could have solar cells fixed onto the outside of its casing to allow the batteries to recharge when light falling on the unit sufficient for this. This could allow the unit to operate continually without any attention at all (normal periodic battery charging) and form part of a completely automatic monitoring system.

If power is available from a vehicle's system, the unit could utilise this power source and not have to rely on its internal batteries.

The camera vehicle itself could register its own position on its route, and could trigger the unit directly rather than having to use an external sensor transmitting a command to the units' receiver.

If location does not need to be known to a precision of 10 metres or better, a trigger command signal can come from a GPS (Global Positioning System) receiver contained within or attached to the unit.

If external lighting can be arranged, the unit need not provide its own light source. This simplifies the unit and reduces its battery power consumption.

Multiple image sensors may be attached to a single unit to take many different simultaneous pictures on the one unit rather than using several units for the same task

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-49. (canceled)

50. An image capture and retrieval apparatus including:
an image sensor for capturing data relating to a visual image;
means for triggering the image sensor to capture the image data at a predetermined time and/or location;
a base station for retrieving and processing the image data; and
a moveable unit including data storage means for storing the image data and data transmission means for transmitting the image data, the moveable unit being adapted for conveying to the base station image data captured by the image sensor at a location remote from the base station.

51. Image capture and retrieval apparatus according to claim 50, wherein the moveable unit is able to convey data from a remote location at least 10 m away from the base station.

52. Image capture and retrieval apparatus according to claim 50, wherein the image sensor forms part of the moveable unit.

53. Image capture and retrieval apparatus according to claim 50, wherein the moveable unit includes a light source for illuminating the image.

54. Image capture and retrieval apparatus according to claim 53, wherein the light source includes a flash unit.

55. Image capture and retrieval apparatus according to claim 53, wherein the light source includes one or more light emitting diodes.

56. Image capture and retrieval apparatus according to claim 53, wherein the apparatus includes a means for triggering the light source to provide illumination when the image sensor is triggered to capture the image data.

57. Image capture and retrieval apparatus according to claim 50, wherein the moveable unit includes a power source.

58. Image capture and retrieval apparatus according to claim 57, wherein the moveable unit includes a power controller for switching power on and off as required by the data storage means, the data transmission means, the image sensor and the light source.

59. Image capture and retrieval apparatus according to claim 57, wherein the moveable unit includes a motion detector for use in placing the power source in a low power state when the moveable unit is stationary and the data transmission means are not operating.

60. Image capture and retrieval apparatus according to claim 50, wherein the means for triggering the image sensor to capture the image data includes a radio receiver located on the moveable unit.

61. Image capture and retrieval apparatus according to claim 50, wherein the data transmission means includes a radio transmitter.

62. Image capture and retrieval apparatus according to claim 61, wherein the radio transmitter includes means for transmitting the image data in discrete blocks.

63. Image capture and retrieval apparatus according to claim 50, wherein the moveable unit includes means for removeably attaching it to a vehicle unit.

64. Image capture and retrieval apparatus according to claim 63, wherein the vehicle unit includes wheels or is adapted to travel on a track.

65. Image capture and retrieval apparatus according to claim 64, wherein the vehicle unit comprises, or forms part of, a car for a roller coaster or similar amusement ride.

66. Image capture and retrieval apparatus according to claim 50, wherein the transmission means on the moveable unit includes means for transmitting information relating to the status of the moveable unit.

67. Image capture and retrieval apparatus according to claim 66, wherein such information includes battery charge state, number of images captured, and information relating to the status of the light source.

68. Image capture and retrieval apparatus according to claim 50, wherein the moveable unit includes a housing which is no more than 0.3 metres in height, 0.3 metres in width and 0.1 metres in depth.

69. Image capture and retrieval apparatus according to claim 68 wherein the housing is no more than 0.2 metres in height, 0.2 metres in width and 0.05 metres in depth.

70. Image capture and retrieval apparatus according to claim 68, wherein substantially all the components of the moveable unit are contained within the housing.

71. Image capture and retrieval apparatus according to claim 50, wherein the moveable unit weighs less than 1 kg.

72. Image capture and retrieval apparatus according to claim 68, wherein the housing includes a front surface including two clear optical windows for the image sensor and the light source respectively.

73. Image capture and retrieval apparatus according to claim 72, wherein the windows are made of plastics material.

74. Image capture and retrieval apparatus according to claim 68, wherein the housing is waterproof.

75. Image capture and retrieval apparatus according to claim 68, wherein the housing is made of plastics material.

76. Image capture and retrieval apparatus according to claim 68, wherein the housing includes means for attaching it to the vehicle unit, for carrying the moveable unit.

77. Image capture and retrieval apparatus to according claim 68, wherein the housing includes means for attaching a battery charger thereto.

78. Image capture and retrieval apparatus according to claim 50, wherein the apparatus includes a plurality of moveable units each including any of the aforementioned features.

79. Image capture and retrieval apparatus according to claim 78, wherein each moveable unit is uniquely identified such that the base station may identify image data transmitted therefrom.

80. Image capture and retrieval apparatus according to claim 50, wherein the apparatus includes a track extending between the base unit and the remote location, defining a predetermined route for the moveable unit.

81. Image capture and retrieval apparatus according to claim 80, wherein the means for triggering the image sensor to capture the image data includes a stationary trigger unit located at a predetermined position on the predetermined route.

82. Image capture and retrieval apparatus according to claim 81, wherein the trigger unit includes a radio transmitter for providing a signal receivable by the radio receiver on the moveable unit.

83. Image capture and retrieval apparatus according to claim 82, wherein the base station includes interrogation means for causing the transmission of image data from a moveable unit.

84. Image capture and retrieval apparatus according to claim 83, wherein the interrogation means includes means for providing a radio signal receivable by the radio receiver on the moveable unit.

85. Image capture and retrieval apparatus according to claim 50, wherein the base station includes processor means for converting the image data to RGB data for image display.

86. Image capture and retrieval apparatus according to claim 50, wherein the base station includes means for checking the image data for errors and triggering the transmission means on the moveable unit to re-transmit image data if required.

87. Image capture and retrieval apparatus according to claim 86, wherein the base station includes means for receiving image data transmitted in discrete blocks.

88. Image capture and retrieval apparatus according to claim 87, wherein the base station includes means for reconstructing an image from blocks of data received in any arbitrary order.

89. Image capture and retrieval apparatus according to claim 88, wherein each data block includes a sequence number.

90. A method for image capture and retrieval, the method including the steps of:
triggering an image sensor to capture data relating to a visual image, at a predetermined location;
storing the image data and conveying the image data on a moveable unit to a base station remote from the predetermined location;
transmitting the image data to the base station; and
processing the image data at the base station.

91. A method according to claim 90, wherein the image sensor is conveyed with the moveable unit.

92. A method according to claim 90, wherein the moveable unit is conveyed on a vehicle unit, which includes wheels or runs on a track.

93. A method according to claim 90, wherein the method includes the step of triggering a light source to illuminate the image when the image sensor is triggered to capture the image data.

94. A method according to claim 90, wherein the image data is transmitted to the base unit via radio transmission.

95. A method according to claim 94, wherein the image data is transmitted in discrete blocks.
